(19) United States
(12) Patent Application Publication
(10) Pub. No.: US 2025/0364823 A1
(43) Pub. Date: Nov. 27, 2025

(54) SYSTEM AND METHOD FOR MANAGING BATTERY ELECTRIC MACHINES AT WORKSITES

(71) Applicant: Caterpillar Inc., Peoria, IL (US)

(72) Inventors: Adam Lewis, Holland Park (AU); Alison Brandon, Upper Brookfield (AU); Russell Allen Brockhurst, Carindale (AU)

(73) Assignee: Caterpillar Inc., Peoria, IL (US)

(21) Appl. No.: 18/670,795

(22) Filed: May 22, 2024

(51) Int. Cl. H02J 7/00; B60L 3/00; B60L 53/66; B60L 58/12; B60L 58/24

(52) U.S. Cl. CPC H02J 7/0047; B60L 3/0046; B60L 58/12; B60L 58/24; H02J 7/00032; B60L 53/66; B60L 2200/40

(57) ABSTRACT

A system for managing battery electric machines (BEMs) at a worksite is disclosed. The system includes a processor configured to receive battery state information from the BEMs and determine a primary battery state and a secondary battery state. Further, the processor is configured to identify a BEM requiring controller action and determine the controller action corresponding to the identified BEM based on the secondary battery state and a short interval control (SIC) plan. Furthermore, the processor is configured to provide the battery state information of the BEMs and provide the primary battery state of the identified BEM visually distinct from the primary battery state of the other BEMs on the display. The processor is also configured to provide the secondary battery state corresponding to the identified BEM and provide the determined controller action.

### TECHNICAL FIELD

The present disclosure relates, in general, to battery electric machines (BEMs), and more particularly to, computer-implemented systems and methods for managing the BEMs at worksites.

### BACKGROUND

Battery electric machines (BEMs) operating at a work site such as a mine site may be depleted of electric charge in an onboard storage device, such as a battery, during machine operations that may include one or more movements of the entire BEM, one or more tools associated with the BEM, or one or more other articulatable portions of the machine. Hence, the BEMs may need to be charged frequently to ensure that sufficient battery charge is available for timely completion of work via the machine operations at the work site. In addition, with an increasing number of the BEMs operating at the work site, monitoring, and managing battery charging, consumption, or faults for each BEM constantly may be time consuming and require manual expertise and effort. Moreover, tracking battery related information gathered from the multiple BEMs may also be overwhelming, in that, a site or fleet supervisor could potentially be left feeling confused as to which BEMs are being monitored. As a result, the site/fleet supervisor may be distracted from or entirely overlook one or more issues related to the BEMs arising during the machine operations at the worksite. When these distractions occur, the site/fleet supervisor may commit errors by taking operational decisions that may result in sub-optimal execution of tasks at the worksite. Consequently, productivity may be affected, causing undesirable delays in the execution of tasks and overall operation. Therefore, continuously monitoring and/or tracking these BEMs is exhausting to the site/fleet supervisor and may adversely impact health conditions of the site/fleet supervisor.

Chinese Patent CN 214833048 U relates to an electric loader. The pure electric loader comprises a display device, a display control device, air pressure detection equipment, oil temperature detection equipment and a battery management system. The display device comprises an air pressure information display area, an oil temperature information display area, a battery electric quantity information display area, a battery temperature information display area, a liquid crystal display area and a fault indication area. The display control device generates a fault display signal according to the air pressure information, the oil temperature information, the battery electric quantity information and the battery temperature information and sends the fault display signal to the display device, so that the display device displays fault information in a fault indication area and/or a liquid crystal display area. Therefore, the pure electric loader can display the air pressure information, the oil temperature information, the battery electric quantity, the battery temperature and the like of the pure electric loader, the function parameter information capable of being displayed is complete, and a user can conveniently find fault information in time when a fault occurs. However, for instances when multiple such loaders or machines are involved at the worksite, monitoring such machines, and determining proactive or corrective actions for each such machine taking into consideration worksite task requirements and timelines may be complicated.

### SUMMARY

In an aspect of the present disclosure, a system for managing battery electric machines (BEMs) at a worksite is disclosed. The system includes a transceiver and a processor communicably coupled thereto. The processor is configured to receive battery state information from the BEMs operating at the worksite via the transceiver. The processor is also configured to determine a primary battery state and at least one secondary battery state associated with the primary battery state based on the received battery state information. Further, the processor is configured to identify at least one BEM of the BEMs requiring at least one controller action based on the primary battery state or the secondary battery state. The processor may also be configured to detect at least one machine related event in order to identify the BEM(s). In addition, the processor is configured to determine the controller action for the detected machine related event corresponding to the identified BEM based on the secondary battery state and a short interval control (SIC) plan including a plurality of planned tasks over a short-interval timeline. Furthermore, the processor is configured to provide the battery state information of the BEMs on a display. The processor is configured to provide the primary battery state of the identified BEM visually distinct from the primary battery state of the other BEMs on the display. The processor is also configured to provide the secondary battery state associated with the primary battery state corresponding to the identified BEM on the display. In addition, the processor is configured to provide the determined controller action.

In another aspect of the present disclosure a battery electric machine (BEM) system is disclosed. The BEM system includes battery electric machines (BEMs) and a system in communication the BEMs via a network. The BEM system is configured to receive battery state information from the BEMs operating at a worksite via the transceiver. The BEM system is also configured to determine a primary battery state and at least one secondary battery state associated with the primary battery state based on the received battery state information. Further, the BEM system is configured to identify at least one BEM of the BEMs requiring at least one controller action based on the primary battery state or the secondary battery state. The BEM system is also configured to detect at least one machine related event in order to identify the BEM(s). In addition, the BEM system is configured to determine at least one controller action for the detected machine related event for the identified BEM based on the corresponding secondary battery state and a short interval control (SIC) plan including a plurality of planned tasks over a short-interval timeline. Furthermore, the BEM system is configured to provide the battery state information of the BEMs on a display. The BEM system is configured to provide the primary battery state of the identified BEM visually distinct from the primary battery state of the other BEMs on the display. The BEM system is also configured to provide the secondary battery state associated with the primary battery state corresponding to the identified BEM on the display. In addition, the BEM system is configured to provide the determined controller action.

In yet another aspect of the present disclosure, a method for managing battery electric machines (BEMs) at a worksite is disclosed. The method includes a step of receiving battery state information from the BEMs operating at the worksite. The method also includes a step of determining a primary battery state and at least one secondary battery state associated with the primary battery state based on the received battery state information. Further, the method includes a step of identifying at least one BEM of the BEMs requiring at least one controller action based on the primary battery state or the at least one secondary battery state. The step of identifying further includes a step of detecting at least one machine related event in order to identify the BEM(s). In addition, the method includes a step of determining the controller action for the detected machine related event corresponding to the at least one identified BEM based on the at least one secondary battery state and a short interval control (SIC) plan including planned tasks over a short-interval timeline. Furthermore, the method includes a step of providing the battery state information of the BEMs on a display. The step of providing the battery state information includes a step of providing the primary battery state of the at least one identified BEM visually distinct from the primary battery state of the other BEMs. Further, the step of providing the battery state information includes providing the at least one secondary battery state associated with the primary battery state corresponding to the at least one identified BEM. In addition, the step of providing the battery state information includes a step of providing the determined controller action.

### BRIEF DESCRIPTION OF DRAWINGS

FIG. 1 is an exemplary diagrammatic illustration of a battery electric machine (BEM) system at a worksite, in accordance with different embodiments of the present disclosure;

FIG. 2 is a schematic diagrammatic illustration of a machine management system of the BEM system of FIG. 1 for managing the BEMs at the worksite, in accordance with the embodiments of the present disclosure;

FIGS. 3 is an exemplary diagrammatic illustration of primary visual indicators associated with primary battery states of the BEMs provided on a display by the machine management system of FIG. 2, in accordance with the embodiments of the present disclosure;

FIGS. 4 is an exemplary diagrammatic illustration of secondary visual indicators associated with secondary battery states of the BEMs provided on a display by the machine management system of FIG. 2, in accordance with the embodiments of the present disclosure;

FIG. 5 is an exemplary diagrammatic illustration of user interface (UI) cards including the primary visual indicators of FIG. 3 provided on a display as graphical representations of the BEMs and the primary battery states of the BEMs respectively by the machine management system of FIG. 2; in accordance with the embodiments of the present disclosure;

FIG. 6 is an exemplary diagrammatic illustration of the UI cards of FIG. 5 and a digital map including the BEMs provided on a display in different graphical user interfaces (GUIs) respectively by the machine management system of FIG. 2, in accordance with the embodiments of the present disclosure;

FIG. 7 is an exemplary diagrammatic illustration of the secondary visual indicators of FIG. 4 provided in response to receiving a controller input corresponding to the primary visual indicators of FIG. 3 by the machine management system of FIG. 2, in accordance with the embodiments of the present disclosure;

FIG. 8 is an exemplary diagrammatic illustration of the secondary visual indicators, controller actions, and a modified SIC plan provided on a display in different GUIs by the machine management system of FIG. 2, in accordance with the embodiments of the present disclosure; and

FIG. 9 is an exemplary flowchart of a method for managing the BEMs, in accordance with the embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1, 1″, 101 and 201 could refer to one or more comparable components used in the same and/or different depicted embodiments.

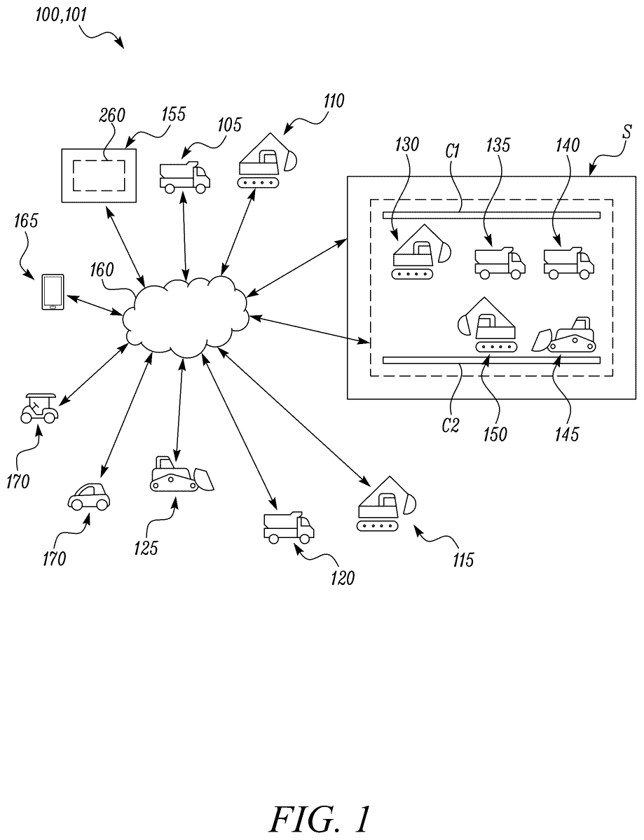

Referring to FIG. 1, an exemplary diagrammatic illustration of a battery electric machine (BEM) system 100 is disclosed. The BEM system 100 includes battery electric machines (BEMs) 105-50 and a machine management system 155 for managing the BEMs 105-150 at a worksite 101. Examples of the worksite 101 include, but are not limited to, an electrified mining site, quarry, construction site, and/or warehouse. Examples of the BEMs 105-150 include, but are not limited to, haul trucks, water trucks, loaders, excavators, shovels, and tractors. In some embodiments, the machine management system 155 may be in communication with the battery electric machines 105-150 via a network 160. In some embodiments, the BEM system 100 may also include one or more remote maintenance devices 165 and/or machines 170 in communication with the machine management system 155 via the network 160. Examples of the machine management system 155 and/or the remote maintenance devices 165 include, but are not limited to, computers, laptops, mobile devices, handheld devices, personal digital assistants (PDAs), tablet personal computers, digital notebook, automatic teller machines (ATMs), wearables, and other electronic devices known to persons skilled in the art for performing functions consistent with this disclosure. Examples of the remote maintenance machines 170 include, but are not limited to, service or repair vehicles. Examples of the network 160 include, but are not limited to, a Local Area Network (LAN), a Wireless Local Area Network (WLAN), a Small Area Network (SAN), a Wi-Fi Direct Network and a telecommunication network including, but not limited to, a fourth generation (4G) and a fifth generation (5G) cellular network.

The BEMs 105-125 may be operational and configured to perform different tasks at different locations at the worksite 101 and the BEMs 130-150 may be stationed at a charging station S for charging. The machine management system 155 may be configured to receive battery state information from the BEMs at the worksite 101 via the network 160. The machine management system 155 may also be configured to determine a primary battery state and at least one secondary battery state associated with the primary battery state based on the received battery state information. Further, the machine management system 155 may be configured to identify at least one BEM of the BEMs 105-150 requiring at least one controller action based on the primary battery state or the secondary battery state. In some embodiments, a controller may correspond to an individual assigned for managing multiple BEMs, including, but not limited to, an office user or a supervisor operating the machine management system 155, or a pit supervisor in a light vehicle or a machine operator having access to the machine management system 155 via a portable and/or remote electronic device (not shown). For example, the controller may correspond to a loading tool operator assigned to manage all associated or allocated loaders or loading trucks via the machine management system 155. In some embodiments, the controller may also correspond a controller module 260 of the machine management system 155.

The machine management system 155 may also be configured to detect at least one machine related event in order to identify the BEM(s). In addition, the machine management system 155 may be configured to determine the controller action for the detected machine related event corresponding to the identified BEM based on the secondary battery state and a short interval control (SIC) plan. The SIC plan may include multiple planned tasks over a short-interval timeline. Furthermore, the machine management system 155 may be configured to provide the battery state information of the BEMs on a display. In some embodiments, the machine management system 155 may be configured to provide the primary battery state of the identified BEM visually distinct from the primary battery state of the other BEMs on the display. In some embodiments, the machine management system 155 may also be configured to provide the secondary battery state associated with the primary battery state corresponding to the identified BEM on the display. In addition, the machine management system 155 may be configured to provide the controller action determined on the display. In some embodiments, the machine management system 155 may also be configured to automatically implement the determined controller action. It may be understood that, in some embodiments, the machine management system 155 may be configured to automatically implement the controller action via the controller module 260 by communicating with the identified BEMs or the remote maintenance devices 165 and/or machines 170 via the network 160. In some embodiments, the maintenance devices 165 and/or machines 170 may be operated by users or work operators.

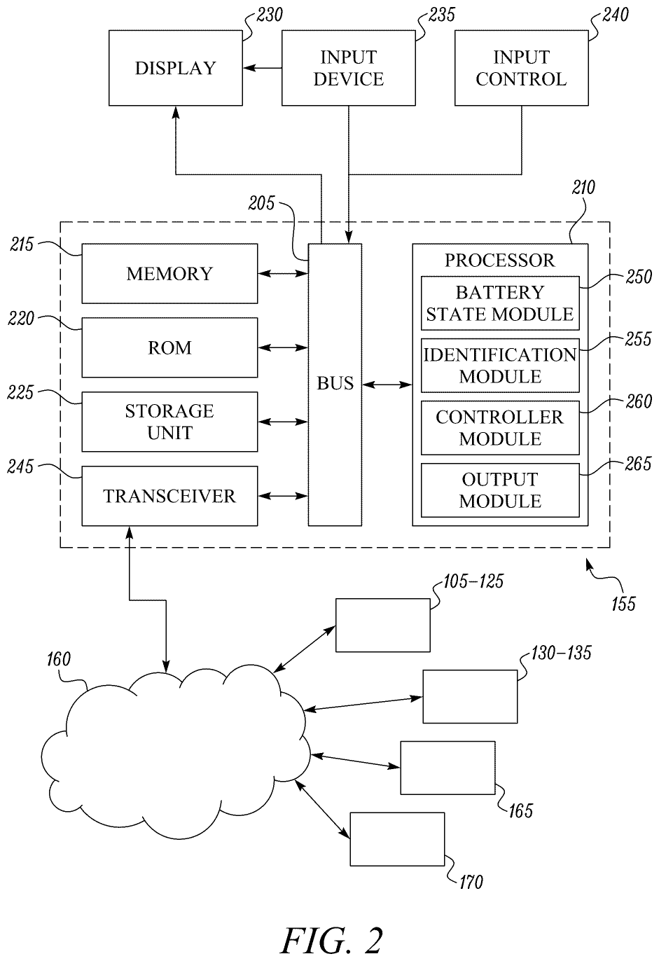

Referring to FIG. 2, a schematic illustration of the machine management system 155 of FIG. 1 for managing the BEMs is disclosed. The machine management system 155 includes a bus 205 or other communication mechanism for communicating information, and a processor 210 coupled with the bus 205 for processing information. The machine management system 155 also includes a memory 215, such as a random-access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The machine management system 155 further includes a read only memory (ROM) 220 or other static storage device coupled to bus 205 for storing static information and instructions for the processor 210.

A storage unit 225, such as a magnetic disk or optical disk, is provided and coupled to the bus 205. The storage unit 225 may store predefined machine related information corresponding to the BEMs, for example, 105-150 respectively. The predefined machine related information corresponding to each BEM may include, but is not limited to, a type of the BEM, a utility associated with the BEM, one or more operations to be performed by the BEM, a time required to complete the operation(s) by the BEM, a criticality associated with the operation(s), battery state information associated with the BEM, and the short interval control (SIC) plan including the planned tasks over a short-interval timeline. The SIC plan may also include a status of the planned tasks, estimated time associated with each planned task, available tasks, completed tasks, and actual time taken corresponding to the completed tasks. The battery state information may include, but are not limited to, a primary battery state and one or more secondary battery states associated with the primary battery state. The primary battery state may correspond to, but is not limited to, a battery consumption state, a battery charging state, and a battery fault state. The secondary battery states may be indicative of a battery charging capacity associated with the BEM, an amount of a battery charge determined in the BEM, a number of a battery charge cycle in the BEM, an operating range of the BEM determined based on the determined amount of the battery charge, a threshold battery charge corresponding to the BEM, a target battery charge corresponding to the BEM required to perform the operation(s), and a criticality of the amount of the battery charge determined based on the threshold battery charge. It may be understood that the threshold battery charge and the target battery charge for each BEM may be predefined in the machine management system 155. It may be understood that, throughout the present disclosure, the battery of each BEM may correspond to a single battery or multiple batteries or battery packs used in the BEM to power and drive the BEM. In some embodiments, the storage unit 225 may also store one or more predefined normal or desirable values and one or more predefined abnormal or undesirable values corresponding to each secondary battery state. In some embodiments, the storage unit 225 may also store one or more machine learning, artificial intelligence, logical, and/or conditional modules, algorithms, and/or models. It may be understood that the information stored in the storage unit 225 may be accessed by the processor 210 via the memory 215 to perform one or more functions.

The machine management system 155 can be coupled via the bus 205 to a display 230, such as a light emitting diode (LED) and a liquid crystal display (LCD) for displaying information to a controller, such as a supervisor. An input device 235 is coupled to bus 205 for communicating information and command selections to the processor 210. The input device 235 may be included in the display 230, for example a touch screen that facilitates detection of multi-touch inputs from the user via the display 230. The input device 235 may also correspond to peripheral input devices that may be paired with the machine management system 155 via Bluetooth, Wi-Fi, Wi-Fi direct, or as a hardware connection such a USB peripheral to the machine management system 155. Examples of the peripheral input devices include, but are not limited to, a joystick, a gamepad, a keyboard, a mouse, a gesture-controlled device, or a wearable device such as, for example, a smart watch. In some embodiments, the input device 235 may also correspond to a microphone (not shown) provided in the machine management system 155 that is configured to received audio inputs or instructions from one or more controllers or supervisors. In some embodiments, the input device 235 may also include alphanumeric and other keys. Another type of user input device is an input control 240, such as a mouse, a trackball, or cursor direction keys for communicating direction information and command selections to the processor 210 and for controlling cursor movement on the display 230.

Various embodiments are related to the use of machine management system 155 for implementing the techniques described herein. In one embodiment, the techniques are performed by the machine management system 155 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In an embodiment implemented using the machine management system 155, various machine-readable medium is involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine. Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that comprise the bus 205. Transmission media can also take the form of acoustic or light waves, such as those generated during radio-wave and infra-red data communications. Examples of machine-readable medium may include, but are not limited, to a carrier wave as described hereinafter or any other medium from which the machine management system 155 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the machine management system 155 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored in the storage unit 225 either before or after execution by the processor 210.

The machine management system 155 also includes a transceiver 245 coupled to the bus 205. The transceiver 245 provides a two-way data communication coupling with the BEMs 105-150. For example, the transceiver 245 can be an integrated service digital network (ISDN) card or a modem to provide a data communication connection to a corresponding type of telephone line. As another example, the transceiver 245 can be a local area network (LAN) card to provide a data communication connection to a compatible LAN. Wireless links can also be implemented. In any such implementation, the transceiver 245 sends and receives radio, electrical, electromagnetic, or optical signals that carry digital data streams representing various types of information.

In some embodiments, the processor 210 may be capable of executing the computer instructions stored in the memory 215 to perform one or more functions. In some embodiments, the processor 210 may include one or more modules 250-265 to perform the one or more functions. For example, the processor 210 may include a battery state module 250, an identification module 255, a controller module 260, and an output module 265. It may be understood that the modules 250-265 may correspond to and/or include hardware and/or software components respectively and may be configured to perform respective functions. It may also be understood that, in some embodiments, the modules 250-265 may implement one or more machine learning, artificial intelligence, logical, and/or conditional operations, modules, algorithms, and/or models to perform respective functions.

The battery state module 250 may be configured to receive battery state information from the BEMs operating at the worksite 101 via the transceiver 245 and the network 160. In some embodiments, the battery state module 250 may be configured to receive the battery state information from the BEMs 105-150 in real-time or periodically within a predefined time. In some embodiments, based on the received battery state information, the battery state module 250 may be configured to determine a primary battery state and at least one secondary battery state associated with the primary battery state corresponding to the BEMs 105-150 respectively. In some embodiments, the primary battery state of a BEM may correspond to a battery charging state, a battery consumption state, and/or a battery fault state. The battery consumption state may be indicative of the BEMs, for example, BEMs 105-125 in operation and consuming electrical energy stored in the batteries of the BEMs 105-125. The battery charging state may be indicative of the batteries of the BEMs, for example, the BEMs 130-150 being charged at a charging station S including, but not limited to, one or more charging rails, for example, C1, C2, or charging points. The battery fault state may be indicative of a fault or an abnormality in a functioning of the battery of a BEM for example, BEM 105, or a battery connection of a BEM, for example, the BEM 130 with an electric power supply at the charging station S.

In some embodiments, the primary battery state may also be indicative of a battery charge of the BEMs 105-150 determined corresponding to the battery charging state, the battery consumption state, and/or the battery fault state. In some embodiments, the battery charge may correspond to a state of charge (SoC) or a depth of discharge (DoD) of the batteries of the BEMs 105-150. The SoC quantifies a remaining capacity available in a battery at a given time and in relation to a given state of battery ageing. The DoD corresponds to a capacity that is discharged from a fully charged battery, divided by battery nominal capacity. In some embodiments, the secondary battery state may be indicative of the battery charge, a battery temperature, an electric power train temperature, a time of receipt of the battery state information, the target battery charge associated with the BEMs 105-150, a first estimated time for the battery charge to be greater than or equal to the target battery charge, a second estimated time for the battery charge to be less than or equal to the threshold battery charge, a regenerative battery charging state, an electric power connection state, a number of battery cycles, a battery capacity, a battery power supply disruption state, a battery fault state, a battery charging fault state, and/or a battery connection fault state. In some embodiments, the battery state module 250 may determine the first estimated time and the second estimated time based on the battery charge of the BEMs 105-150 determined at a given point in time.

In some embodiments, the secondary battery states associated with the battery charging state may correspond to the battery charge, the time of receipt of the battery state information, the target battery charge associated with the BEMs, for example, BEMs 130-150, the first estimated time for the battery charge to be greater than or equal to the target battery charge, the electric power connection state, the number of battery cycles, and/or the battery capacity. The electric power connection state may be indicative of an electric power connection and supply provided to the batteries of the BEMs, for example, BEMs 130-150. In some embodiments, the secondary battery states associated with the battery consumption state may correspond to the battery charge, the battery temperature, the electric power train temperature, the time of receipt of the battery state information, the second estimated time for the battery charge to be less than or equal to the threshold battery charge, and/or the regenerative battery charging state. The regenerative battery charging state may be indicative of the batteries of the BEMs, for example, BEMs 105-125, being charged using electrical power generated from braking of the BEMs 105-125 during operation and conversion of the kinetic energy from the braking into the electrical power. In some embodiments, the secondary battery states associated with the battery fault state may correspond to the battery charge, the time of receipt of the battery state information, battery power supply disruption state, the battery malfunction state, the battery charging fault state, and/or the battery connection fault state. The battery malfunction state may be indicative of improper, undesirable, or critical battery abnormalities including, but not limited to, battery chemical leakage and battery overheating. The battery power supply disruption state may be indicative of a disconnection of an electric power supply to the batteries of the BEMs, for example, the BEMs 130-150 at the charging rails C1, C2 of the charging station S. The battery charging fault state may be indicative of abnormal charging of the batteries of the BEMs, for example, the BEMs 130-150. The battery connection fault state may be indicative of a discontinuity in the charging of the batteries of the BEMs, for example, the BEMs 130-150, despite the electric power supply, due to a faulty connection of the BEMs 130-150 with the electric power source.

In some embodiments, the battery state module 250 may also be configured to determine one or more values corresponding to each secondary battery state. For example, for the BEM 130 determined to be in the battery charging state, the battery state module 250 may be configured to determine that the current battery charge of the BEM 130 is equal to 30 percent of the battery capacity, the target battery charge of the BEM 130 is equal to 80 percent of the battery capacity, the number of battery cycles is equal to 800, the battery capacity of the batteries in the BEM 130 is equal to 100 kilowatt-hour (kWh). Similarly for the BEM 105 determined to be in the battery consumption state, the battery state module 250 may be configured to determine that the current battery charge is equal to 50 percent of the battery capacity, the battery temperature is equal to 20 degrees Celsius, and the electric power train temperature is equal to 30 degrees Celsius.

In some embodiments, the battery state module 250 may be configured to determine that the primary battery state corresponds to the battery charging state when the battery charge of the BEMs, for example, the BEMs 130-150, is determined to be increasing in real-time or over a predefined time by the battery state module 250. Similarly, in some embodiments, the battery state module 250 may be configured to determine that the primary battery state corresponds to the battery consumption state when the battery charge of the BEMs, for example, the BEMs 105-125, is determined to be decreasing in real-time or over the predefined time by the battery state module 250. Further, in some embodiments, the battery state module 250 may be configured to determine that the primary battery state corresponds to the battery fault state when an abnormality in charging of the battery of a BEM, for example, the BEM 130 is detected or determined in real-time or over the predefined time by the battery state module 250.

As an example, the battery state module 250 may determine that the primary battery state of the BEM 130 corresponds to the battery charging state and determine the associated secondary battery states to be indicative of a fifty percent battery charge at the time of receipt of the battery state information, an estimated thirty minutes for the battery charge of the BEM 130 to be equal to the target battery charge of eighty percent, and/or a Boolean state of charging of the battery corresponding to the BEM 130. In some embodiments, the Boolean state of charging for the BEM 130 may correspond to ‘true’ for instances when the battery state module 250 determines an increase in the battery charge of the BEM 130 over the predefined period of time. Similarly, the battery state module 250 may determine that the primary battery state of the BEM 105 corresponds to the battery consumption state and determine the associated secondary battery states to be indicative of a forty percent battery charge at the time of receipt of the battery state information, an estimated twenty minutes for the battery charge of the BEM 105 to be equal to the threshold battery charge of twenty percent, and/or a Boolean state of the regenerative battery charging in the battery consumption state corresponding to the BEM 105. In some embodiments, the Boolean state of the regenerative battery charging may correspond to ‘true’ for instances when the battery state module 250 determines a temporary increase in the battery charge of the BEM 105 over the predefined period of time in the battery consumption state. Similarly, the battery state module 250 may determine that the primary battery state of a BEM for example, the BEM 140, corresponds to the battery fault state and determine the associated secondary battery states to be indicative of a constant twenty percent battery charge over a period of predefined time, and/or a Boolean state of the battery power supply disruption state, the battery fault state, the battery charging fault state, and/or the battery connection fault state corresponding to the BEMs 105-150. In some embodiments, the Boolean state of the battery connection fault state, the battery charging fault state, and/or the battery power supply disruption state may correspond to ‘true’ for instances when the battery state module 250 determines a decrease in the battery charge of the BEM 140 in the battery charging state.

The identification module 255 may be configured to identify at least one BEM of the BEMs 105-150 requiring at least one controller action based on the primary battery state, or the one or more associated secondary battery states determined by the battery state module 250. In some embodiments, the identification module 255 may be configured to detect at least one machine related event associated with a BEM based on the primary battery state, or the associated secondary battery states. Examples of the machine related event include, but are not limited to, a battery charge event, a battery consumption event, a battery failure event, or a machine maintenance event. In some embodiments, the identification module 255 may be configured to detect the battery charge event when the battery charge of the BEM is greater than or equal to the target battery charge in the battery charge event. In some embodiments, the identification module 255 may be configured to detect the battery consumption event when the battery charge of the BEM is less than or equal to the threshold battery charge in the battery consumption state. In some embodiments, the identification module 255 may be configured to detect the battery failure event when the determined primary battery state of the BEM corresponds to the battery fault state. In some embodiments, the identification module 255 may be configured to detect the machine maintenance event when one or more abnormal or undesirable values are identified corresponding to the determined values of the secondary battery states. It may be understood that the identification module 255 may be configured to identify the abnormal or undesirable values of the secondary battery states by comparing the values of the secondary battery states determined by the battery state module 250 with the normal or desirable and/or the abnormal or undesirable values of the secondary battery states stored in the storage unit 225. In an example, the identification module 255 may detect the machine maintenance event when a battery or electric power train temperature of the BEM 115 as indicated by the secondary battery state is greater than a threshold battery temperature. In some embodiments, the identification module 255 may also be configured to assign a priority ranging from, but not limited to, normal or medium to high, to the detected machine related event.

In some embodiments, the identification module 255 may be configured to identify the BEM requiring the controller action upon detecting the machine related event. For example, the identification module 255 may be configured to identify a BEM, for example, the BEM 105 as requiring the controller action when the battery consumption event is detected, i.e., when the battery charge of the BEM 105 as indicated by the secondary battery state is less than or equal to the threshold battery charge in the battery consumption state. As an example, the identification module 255 may identify the BEM 105 as requiring the controller action when the battery charge of the BEM 105 is equal to the threshold battery charge of twenty percent. Similarly, the identification module 255 may be configured to identify a BEM, for example, the BEM 140 as requiring the controller action when the battery charge event is detected, i.e., when the battery charge of the BEM 140 is less than or equal to the threshold battery charge or greater than or equal to the target battery charge in the battery charging state. As an example, the identification module 255 may identify the BEM 140 as requiring the controller action when the battery charge of the BEM 140 is equal to the target battery charge of eighty percent. In addition, the identification module 255 may be configured to identify a BEM, for example, the BEM 120, as requiring the controller action when the battery fault event is detected, i.e., when the determined primary battery state of the BEM 120 corresponds to the battery fault state. Similarly, the identification module 255 may be configured to identify a BEM, for example, the BEM 115, as requiring the controller action when the machine maintenance event is detected, i.e., when a battery or electric power train temperature of the BEM 115 as indicated by the secondary battery states is less than, greater than, or equal to a threshold battery temperature.

The controller module 260 may be configured to determine the controller action for the detected machine related event corresponding to the BEM, for example, 105, identified as requiring the controller action by the identification module 255, based on the secondary battery states and the short interval control (SIC) plan. The SIC plan may include multiple planned tasks over a short-interval timeline. For example, in some embodiments, the SIC plan may include the planned tasks organized into short intervals of time, such as, but not limited to, two hours, where a subset of the planned tasks is selected based on predefined task priority for each short interval of time. The SIC plan may accordingly enable a controller embodied as a work supervisor or the controller module 260 to respond immediately to changing circumstances or business priorities, for instance, every two hours. It may therefore be apparent that the SIC plan may be dynamically modified by the controller module 260, and/or be manually modified by the work supervisor based on, but not limited to, actual completion of the planned tasks, time taken for the completion of the planned tasks, and/or changing business/work priorities during the short intervals of time. It may also be apparent that the SIC plan may be updated in real-time or periodically based on the modification. In some embodiments, the work supervisor or the controller module 260 may be configured to modify the SIC plan based on the controller actions determined corresponding to the identified BEMs. In some embodiments, the controller module 260 may also be configured to determine the controller actions based on the priority of the machine related event assigned by the identification module 255.

As an example, the identification module 255 may identify a BEM, for example, the BEM 120 as requiring the controller action when the battery fault event is detected, i.e., when the primary battery state of the BEM 120 corresponds to the battery fault state. The controller module 260 may determine that a planned task A assigned to the BEM 120 may be critical based on the SIC plan in a current short time interval of the SIC plan. Accordingly, the controller module 260 may be configured to apply one or more machine learning and/or artificial intelligence models to determine one or more controller actions for the battery fault state detected corresponding to the identified BEM 120. In some embodiments, a first controller action determined by the controller module 260 may correspond to dispatching a maintenance vehicle to attend to the identified BEM 120. A second controller action determined by the controller module 260 may correspond to dispatching a BEM, for example, the BEM 130 from the charging station S to perform the planned task A when the battery charge of the BEM 130 as indicated by the primary or secondary battery state is equal to or greater than the target battery charge of the BEM 130. A third controller action determined by the controller module 260 may correspond to modifying the SIC plan to reassign a planned task B previously assigned to the BEM 130 to another BEM, for example, the BEM 135 and modify allotted time for the identified BEM 130 in the current short interval of time for the completion of the planned task A.

In another example, the identification module 255 may identify a BEM, for example, the BEM 105 as requiring the controller action when the battery consumption event is detected, i.e., when the battery charge of the BEM 105 is less than or equal to the threshold battery charge of the BEM 105 in the battery consumption state. The controller module 260 may determine that the BEM 105 may be required to operate a predefined number of hours to complete a planned task C assigned to the BEM 105 based on the SIC plan in a current short time interval of the SIC plan. Accordingly, the controller module 260 may be configured to apply one or more machine learning and/or artificial intelligence models to determine one or more controller actions for the battery consumption event corresponding to the identified BEM 105. In some embodiments, a first controller action determined by the controller module 260 may correspond to directing the identified BEM 105 to the charging station S for charging. A second controller action determined by the controller module 260 may correspond to dispatching a BEM, for example, the BEM 145 from the charging station S to perform the planned task C when the battery charge of the BEM 145 as indicated by the primary or secondary battery state is equal to or greater than the target battery charge of the BEM 145. A third controller action determined by the controller module 260 may correspond to modifying the SIC plan to reassign a planned task C previously assigned to the BEM 105 to the BEM 145 in the current short interval of time for the completion of the planned task C. A fourth controller action determined by the controller module 260 may correspond to modifying the SIC plan to reassign a planned task D previously assigned to the BEM 145 to the BEM 105 in the current short interval of time for the completion of the planned task D.

In yet another example, the identification module 255 may identify a BEM, for example, the BEM 150 as requiring the controller action when the battery charge event is detected, i.e., when the battery charge of the BEM 150 is greater than or equal to the target battery charge of the BEM 150 in the battery charging state. The controller module 260 may determine that a planned task E is yet to be allocated or another planned task F previously assigned to another BEM for example, the BEM 115 may be incomplete based on an updated SIC plan in a current short time interval of the SIC plan. Accordingly, the controller module 260 may be configured to apply one or more machine learning and/or artificial intelligence models to determine one or more controller actions for the battery charge event detected corresponding to the identified BEM 150. In some embodiments, a first controller action determined by the controller module 260 may correspond to allocating the planed task E or F to the identified BEM 150. A second controller action determined by the controller module 260 may correspond to dispatching the identified BEM 150 from the charging station S to perform the planned task E or F. A third controller action determined by the controller module 260 may correspond to modifying the SIC plan to assign a planned task E or reassign the planned task F previously assigned to the BEM 115 to the BEM 150 in the current short interval of time for the completion of the planned task E or F.

In some embodiments, the controller module 260 may also be configured to automatically implement one or more of the determined controller actions by directly communicating with and/or providing instructions associated with the determined controller actions to the identified BEMs via the network 160. In some embodiments, the controller module 260 may also be configured to automatically implement the determined controller actions by directly communicating with and/or providing instructions associated with the determined controller actions to the remote maintenance devices or machines 165, 170 (see FIG. 1) via the network 160. For example, the controller module 260 may be configured to implement the determined controller action of dispatching the maintenance vehicle to attend to an identified BEM, for example, 120 by automatically communicating with a remote maintenance vehicle 170 and/or a remote device 165 via the network 160 and providing instructions to the remote maintenance vehicle 170 and/or device 165 to navigate to a location of the identified BEM 120 in order to perform maintenance or repair of the identified BEM 120. In some embodiments, an operator operating the remote maintenance vehicle 170 may receive the determined control actions via a display (not shown) provided in the remote maintenance vehicle 170 and/or via a display on the remote device 165 and direct the remote maintenance vehicle 170 to the location of the identified BEM 120. In another example, the controller module 260 may be configured to implement the determined controller action of directing an identified BEM, for example, 120, to the charging station S (see FIG. 1) by automatically communicating with the identified BEM 120 via the network 160 and providing instructions to the identified BEM 120 to navigate to a location of the charging station S in order to charge the identified BEM 120.

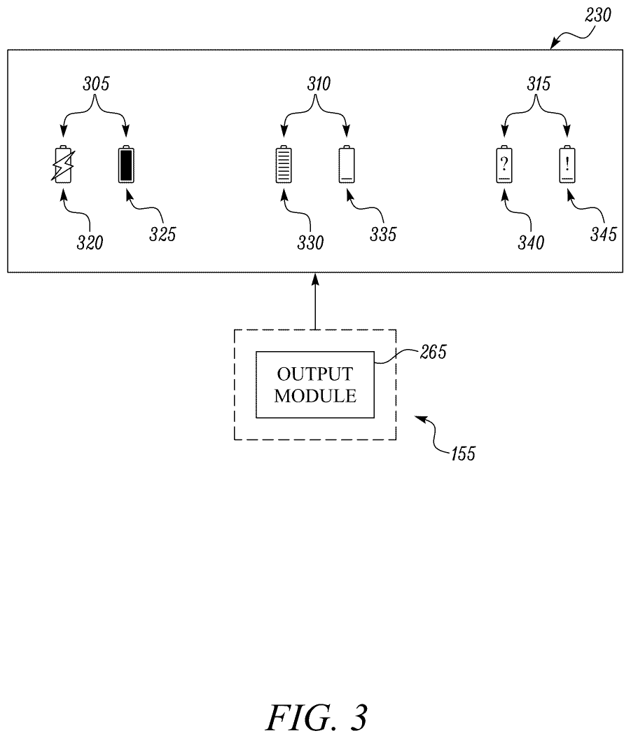

The output module 265 may be configured to provide the battery state information of the BEMs 105-150 on a display, for example, the display 230. In some embodiments, output module 265 may be configured to provide one or more primary visual indicators associated with each primary battery state for each BEM. In some embodiments, as shown in FIG. 3, the output module 265 may be configured to provide the primary visual indicators 305, 310, and 315 corresponding to the battery charging state, the battery consumption state, and the battery fault state respectively visually distinct from each other. For example, the output module 265 may be configured to provide the primary visual indicators 305-315 corresponding to the battery charging state, the battery consumption state, and the battery fault state in different colors and/or symbols on the display 230. In some embodiments, the output module 265 may be configured to provide multiple primary indicators corresponding to and associated with each primary battery state visually distinct from each other. For example, the primary visual indicators 305 corresponding to the battery charging state may include a first primary visual indicator 320 indicative of a battery partially charged state and a second primary visual indicator 325 corresponding to the battery fully charged state. Similarly, the primary visual indicators 310 corresponding to the battery consumption state may include a third primary visual indicator 330 indicative of a normal battery operating state and a fourth primary visual indicator 335 indicative of a low battery state. In addition, the primary visual indicators 315 corresponding to the battery fault state may include a fifth primary visual indicator 340 indicative of a battery warning state and a sixth primary visual indicator 345 indicative of a battery error state.

In some embodiments, the output module 265 may be configured to provide the primary visual indicators 305 associated with the determined battery charging state of a BEM, for example, the BEM 130, in a first color until the battery charge of the BEM 130 is greater than or equal to the target battery charge of the BEM 130. For example, the output module 265 may be configured to provide the first primary visual indicator 320 corresponding to the battery partially charged state in the first color when the BEM 130 is charging. Thereafter, when the battery charge of the BEM 130 is greater than or equal to the target battery charge of the BEM 130, the identification module 255 may be configured to identify the BEM 130 as requiring operation attention. The output module 265 may then be configured to cause a change in color of the first primary visual indicator 320 from the first color to a first highlighted color. In some embodiments, the output module 265 may also be configured to change the first primary visual indicator 320 corresponding to the battery partially charged state in the first color to the second primary visual indicator 325 corresponding to the battery fully charged state in the first highlighted color. In some embodiments, the first color and the first highlighted color may correspond to cool colors including, but not limited to, blue and/or green. For example, the first color of the first primary visual indicator 320 corresponding to the battery partially charged state may correspond to a blue color and the first highlighted color of the second primary visual indicator 325 corresponding to the battery fully charged state may correspond to a green color. In some embodiments, the first highlighted color may have a brightness and/or a saturation greater than the first color. In some embodiments, the change in color of the first primary visual indicator 320 or the change from the first primary visual indicator 320 to the second primary visual indicator 325 on the display 230 may be indicative of the identified BEM 130 requiring the controller action. Accordingly, it may be understood that the output module 265 may be configured to provide the primary battery state of the identified BEM 130 visually distinct from the primary battery state of the other BEMs on the display 230 by causing the change in color of the first primary visual indicator 320 or the change from the first primary visual indicator 320 to the second primary visual indicator 325 on the display 230.

In some embodiments, the output module 265 may be configured to provide the primary visual indicators 310 associated with the determined battery consumption state of a BEM, for example, the BEM 105, in a second color until the battery charge of the BEM 105 less than or equal to the threshold battery charge of the BEM 105. For example, the output module 265 may be configured to provide the third primary visual indicator 330 corresponding to the normal battery state in the second color when the battery charge of the BEM 105 is greater than the threshold battery charge. Thereafter, when the battery charge of the BEM 105 is less than or equal to the threshold battery charge of the BEM 105, the identification module 255 may be configured to identify the BEM 105 as requiring operation attention. The output module 265 may then be configured to cause a change in color of the third primary visual indicator 330 from the second color to a second highlighted color. In some embodiments, the output module 265 may also be configured to change the third primary visual indicator 330 corresponding to the normal battery state in the second color to the fourth primary visual indicator 335 corresponding to the low battery state in the second highlighted color. In some embodiments, the second color may correspond to a neutral color including, but not limited to, beige, taupe, gray, cream, brown, black, and/or white. In some embodiments, the second highlighted color may correspond to a warm color including, but not limited to, orange, yellow, and/or brown, for instances when the battery charge of the BEM 105 is less than or equal to the threshold battery charge of the BEM 105. In some embodiments, the second highlighted color may have a brightness and/or a saturation greater than the second color. In some embodiments, the change in color of the third primary visual indicator 330 or the change from the third primary visual indicator 330 to the fourth primary visual indicator 335 on the display 230 may be indicative of the identified BEM 105 requiring the controller action. Accordingly, it may be understood that the output module 265 may be configured to provide the primary battery state of the identified BEM 105 visually distinct from the primary battery state of the other BEMs on the display 230 by causing the change in color of the third primary visual indicator 330 or the change from the third primary visual indicator 330 to the fourth primary visual indicator 335 on the display 230.

In some embodiments, the output module 265 may be configured to provide the primary visual indicators 315 associated with the determined battery fault state of a BEM, for example, the BEM 120, in a third color or a fourth color. For example, the output module 265 may be configured to provide the fifth primary visual indicator 340 corresponding to the battery warning state in the third color and the sixth primary visual indicator 345 corresponding to the battery error state in the fourth color. In some embodiments, the third color and the fourth color may correspond to the warm colors including, but not limited to, yellow, orange, brown, and/or red. For example, the output module 265 may be configured to provide the fifth primary visual indicator 340 corresponding to the battery warning state in yellow color and the sixth primary visual indicator 345 corresponding to the battery error state in the red color. In some embodiments, the primary visual indicators 315 associated with the determined battery fault state of the BEM 120 provided in the third color or the fourth color on the display 230 may be indicative of the identified BEM 120 requiring the controller action. Accordingly, it may be understood that the output module 265 may be configured to provide the primary battery state of the identified BEM 120 visually distinct from the primary battery state of the other BEMs on the display 230 by providing the primary visual indicators 315 in the third color or the fourth color on the display 230.

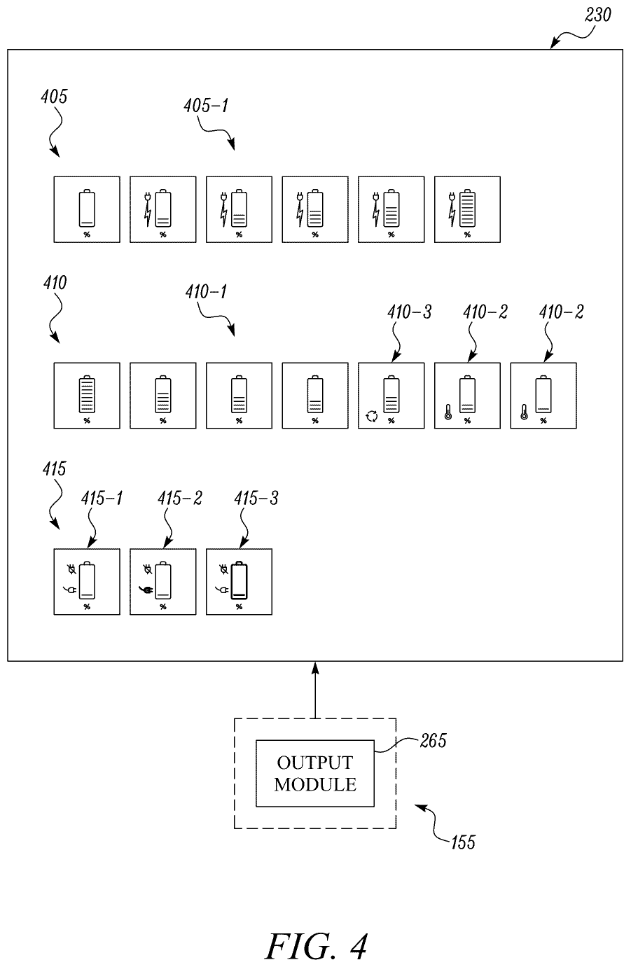

Referring to FIG. 4, in some embodiments, the output module 265 may also be configured to provide one or more secondary visual indicators 405-415 corresponding to the determined secondary battery states associated with each primary battery state, for example, the battery charging state, battery consumption state, and the battery fault state, on the display 230. Accordingly, it may be understood that, in some embodiments, the output module 265 may also be configured to provide the secondary battery states associated with the primary battery state determined corresponding to the one or more BEMs, for example, the BEM 105, the BEM 130, and/or the BEM 120, identified by the identification module 255 as requiring the controller action on the display 230. In some embodiments, the output module 265 may be configured to provide the secondary visual indicators 405-415 in response to receiving a controller or work supervisor input corresponding to the primary visual indicators 320-345 respectively. It may be apparent that the controller or work supervisor input may be received via the input device 235 or via the display 230. In some embodiments, the output module 265 may be configured to provide the secondary battery states 405-415 corresponding to the battery consumption state, the battery charging state, and the battery fault state visual distinct from each other.

For example, the output module 265 may be configured to provide at least one of the secondary visual indicators 405 in response to receiving the controller or work supervisor input corresponding to the first primary visual indicator 320 or the second primary visual indicator 325 associated with the battery charging state. In some embodiments, the secondary visual indicators 405, 405-1 may be indicative of a change in percentage of the battery charge of the BEM, for example, the BEM 130 over a predefined time as indicated by the determined secondary battery state corresponding to the BEM 130.

Similarly, the output module 265 may be configured to provide at least one of the secondary visual indicators 410 in response to receiving the controller or work supervisor input corresponding to the third primary visual indicator 330 or the fourth primary visual indicator 335 associated with the battery consumption state. In some embodiments, the secondary visual indicators 410, 410-1 may be indicative of the change in percentage of the battery charge of the BEM, for example, the BEM 105 over the predefined time as indicated by the determined secondary battery state corresponding to the BEM 105. In some embodiments, the secondary visual indicators 410, 410-2 may also be indicative of a change in temperature of the battery or an electric power train of the BEM, for example, the BEM 105 over the predefined time as indicated by the determined secondary battery state corresponding to the BEM 105. In some embodiments, the secondary visual indicators 410, 410-3 may also be indicative of the regenerative charging of the battery of the BEM, for example, the BEM 105 over the predefined time as indicated by the determined secondary battery state corresponding to the BEM 105.

In some embodiments, the output module 265 may also be configured to provide at least one of the secondary visual indicators 415 in response to receiving the controller or work supervisor input corresponding to the fifth primary visual indicator 340 or the sixth primary visual indicator 345 associated with the battery fault state. In some embodiments, the secondary visual indicators 415, 415-1 may be indicative of the battery charge of a BEM, for example, the BEM 120 being less than or equal to a predefined critical battery charge and/or having no electric power supply or connection as indicated by the determined secondary battery state corresponding to the BEM 120. In some embodiments, the secondary visual indicators 415, 415-2 may also be indicative of the battery charge of a BEM, for example, the BEM 120 being less than or equal to a predefined critical battery charge and/or having electric power supply or connection fault as indicated by the determined secondary battery state corresponding to the BEM 120. In some embodiments, the secondary visual indicators 415, 415-3 may also be indicative of the battery charge of a BEM, for example, the BEM 120 being less than or equal to a predefined critical battery charge and/or having charging fault as indicated by the determined secondary battery state corresponding to the BEM 120.

It may be apparent that the output module 265 may also be configured to provide additional secondary visual indicators associated with other determined secondary battery states corresponding to, but not limited to, a time of receipt of the battery state information, the target battery charge associated with the BEMs 105-150, a first estimated time for the battery charge of a corresponding BEM to be greater than or equal to the target battery charge, a second estimated time for the battery charge of the corresponding BEM to be less than or equal to the threshold battery charge, a number of battery cycles, and a battery capacity of the battery of the corresponding BEM.

In some embodiments, the output module 265 may also be configured to provide the controller action determined by the controller module 260 on the display 230. In some embodiments, the output module 265 may be configured to provide the controller actions corresponding to one or more BEMs, for example, the BEM 105, the BEM 130, and/or the BEM 120, identified by the identification module 255 as requiring the controller action on the display 230. In some embodiments, the output module 265 may be configured to provide the controller actions in response to receiving the controller or work supervisor input corresponding to the primary visual indictors 305-315 associated with determined primary battery state of the identified BEMs.

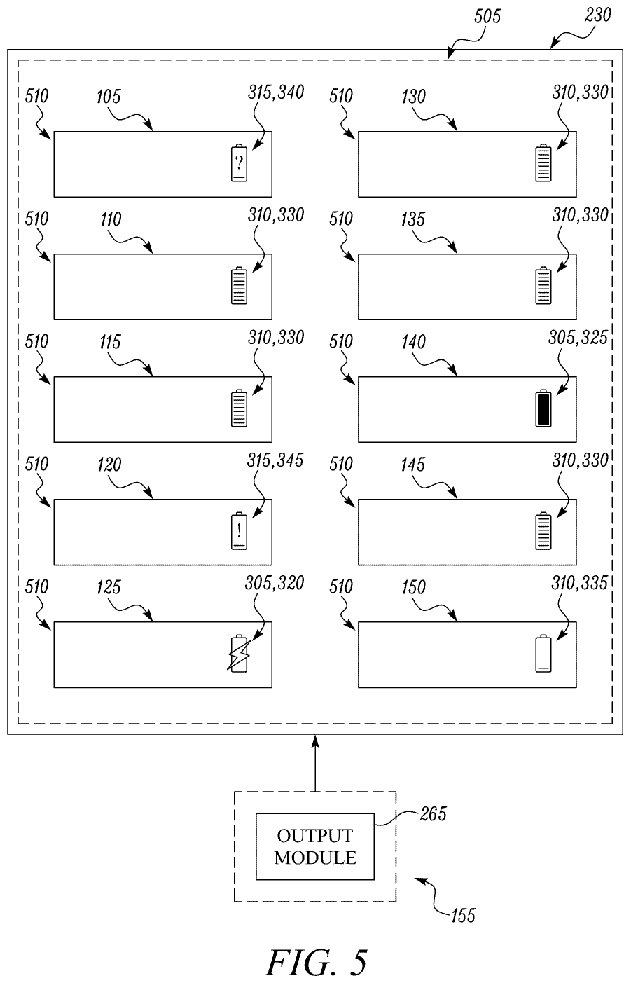

Referring to FIG. 5, in some embodiments, the output module 265 may be configured to provide at least one graphical user interface (GUI) 505 including at least one graphical representation of the BEMs 105-150 respectively on the display 230. In some embodiments, the graphical representations may include the primary visual indicators 305-345 associated with the determined primary battery states of the BEMs 105-150. Examples of the graphical representations of the BEMs 105-150 include, but are not limited to, images, icons, clipart, graphics, user interface (UI) cards 510, and animations. In some embodiments, the output module 265 may be configured to provide the UI cards 510 as the graphical representations of the BEMs 105-150. In some embodiments, the output module 265 may be configured to provide the primary visual indicators 305-345 corresponding to the determined battery state information of the BEMs 105-150 in each UI card of the UI cards 510. Accordingly, the UI card 510 provided on the GUI 505 and including the first primary visual indicator 305, 320, may correspond to a BEM, for example, the BEM 125 having the determined primary battery state that corresponds to a battery charging state and more particularly, to the battery partially charged state. In some embodiments, the output module 265 may be configured to provide the graphical representations, for example, the UI cards 510 of the BEMs 105-150 in the neutral colors, for example, grey.

Accordingly, it may be understood that the output module 265 may be configured to provide the first primary visual indicators, for example, 305, 320 associated with the determined primary battery state corresponding to the battery partially charged state of the BEM 125 in the first color on the GUI 505. The output module 265 may also be configured to provide the second primary visual indicators, for example, 305, 325 associated with the determined primary battery state corresponding to the battery fully charged state of the BEM 140 in the first highlighted color. Similarly, the output module 265 may be configured to provide the third primary visual indicators, for example, 310, 330 associated with the determined primary battery state corresponding to the normal battery state of the BEM 115 in the second color. The output module 265 may also be configured to provide the fourth primary visual indicators, for example, 310, 335 associated with the determined primary battery state corresponding to the low battery state of the BEM 115 in the second highlighted color. Similarly, the output module 265 may be configured to provide the fifth primary visual indicator, for example, 315, 340 associated with the determined primary battery state corresponding to the battery warning state of the BEM 105 in the third color. The output module 265 may be configured to provide the sixth primary visual indicator, for example, 315, 340 associated with the determined primary battery state corresponding to the battery error state of the BEM 120 in the fourth color.

It may also be apparent that, in some embodiments, for instances when the determined primary battery state of the BEMs 105-150 is the battery consumption state and corresponds to a normal battery state, and/or when the primary battery state of the BEMs 105-150 determined is the battery charging state and corresponds to the battery partially charged state, the UI cards 510 on the GUI 505 may predominantly include the first and third primary visual indicators, 320 and 330 in cool and neutral colors respectively. The primary visual indicators 305-345 provided by the output module 265 in neutral and cool colors may be less distracting to a controller, embodied as a supervisor, monitoring the BEMs 105-150. Accordingly, it may be understood that the controller, embodied as a supervisor, may be able to identify the BEMs requiring attention on the display 230 reliably and in a short period of time when the output module 265 causes the change in color of the primary visual indicators 305, 315 from cool or neutral colors to warm colors, and/or the change in the primary visual indicators, for example, from the first and/or third primary visual indicators 320 and 330 to second, fourth, fifth, and/or sixth primary visual indicators 325, 335, 340 and/or 345 in the UI cards 510.

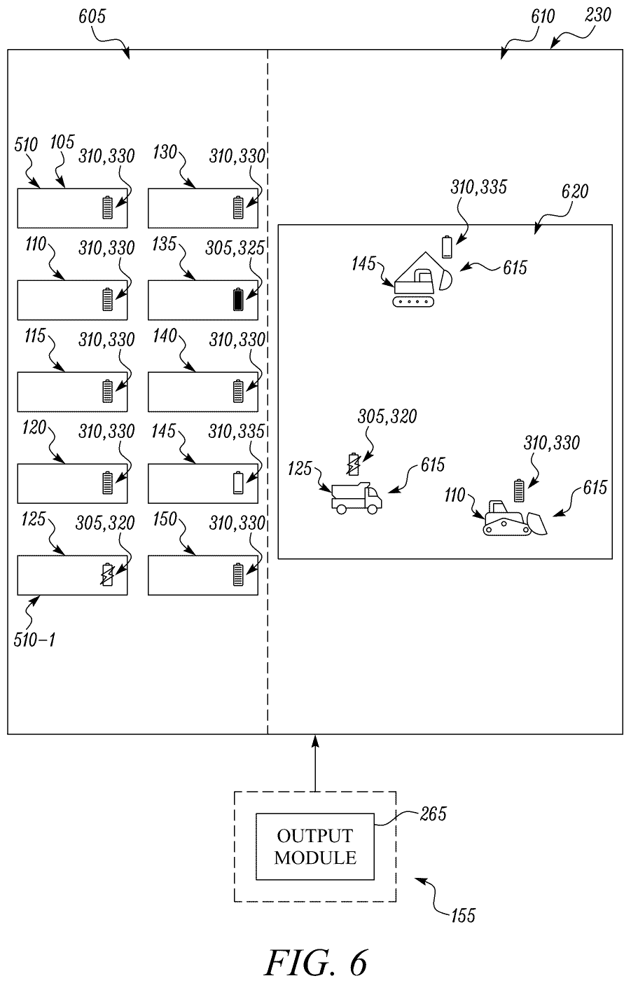

Referring to FIG. 6, in some embodiments, the output module 265 may be configured to provide the battery state information of the BEMs 105-150 on a first GUI 605 and a second GUI 610 on the display 230. In some embodiments, the output module 265 may be configured to provide the graphical representation of the BEMs as the UI cards 510 in the first GUI 605 and as digital animations 615 in a digital map 620 of the worksite 101 (see FIG. 1) on the second GUI 610. In some embodiments, the output module 265 may also be configured to provide a geographical location of the BEMs 105-150 in the digital map 620, an animated movement of the BEMs, for example, the BEMs 110, 125, 145, in the digital map 620, and the primary visual indicators 305-345 corresponding to the digital animations 615 in the digital map 620. In some embodiments, each UI card of the UI cards 510 rendered in the first GUI 605 may be associated with a corresponding graphical representation or the digital animation 615 of a corresponding BEM in the second GUI 610. In some embodiments, upon receiving the controller or work supervisor input corresponding to a UI card for example, the UI card 510-1 in the first GUI 605, the output module 265 may be configured to identify and visually display the corresponding graphical representation or digital animation 615 of the BEM, for example, the BEM 125, associated with the UI card 510-1 in the digital map 620 provided in the second GUI 610.

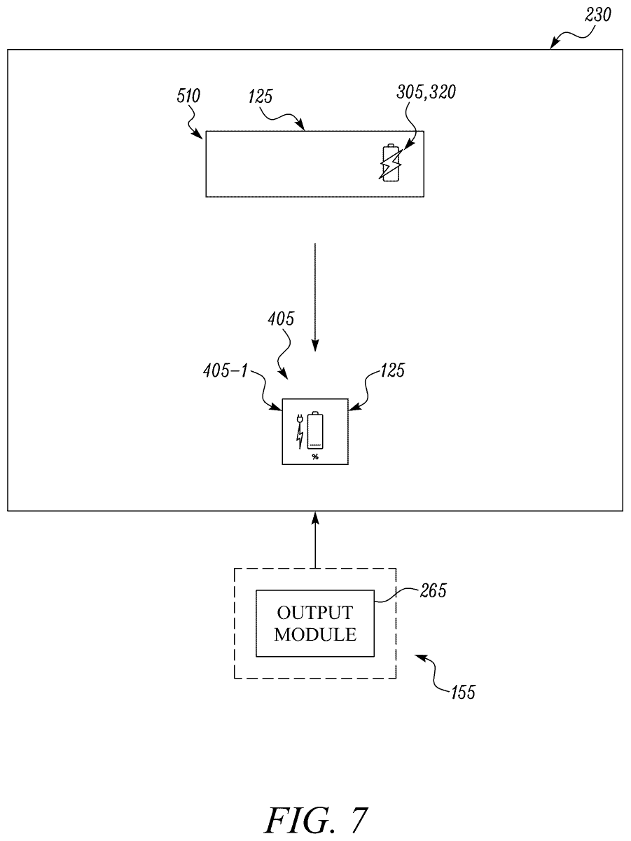

Referring to FIG. 7, in some embodiments, the output module 265 may also be configured to provide the secondary visual indicators, for example, 415 associated with the determined secondary battery states of a corresponding BEM, for example, the BEM 125, in response to receiving the controller or work supervisor input corresponding to the primary visual indicator, for example, 305, 320 or the UI card 510-1 of the BEM 125 including the first primary visual indicator 305, 320. In some embodiments, the output module 265 may also be configured to provide the secondary visual indicators in an interface overlay provided on the first GUI 605 or the second GUI 610, in another GUI overlapping the first GUI 605 and the second GUI 610, and/or in an hover overlay provided on the UI cards 510 or the digital animations 615 when the controller, embodied as a supervisor, may hover a cursor using the input control 240 or maintain a touch contact with the UI cards 510 or the digital animations 615 for a predefined period of time on the display 230 including, for example, a touchscreen.

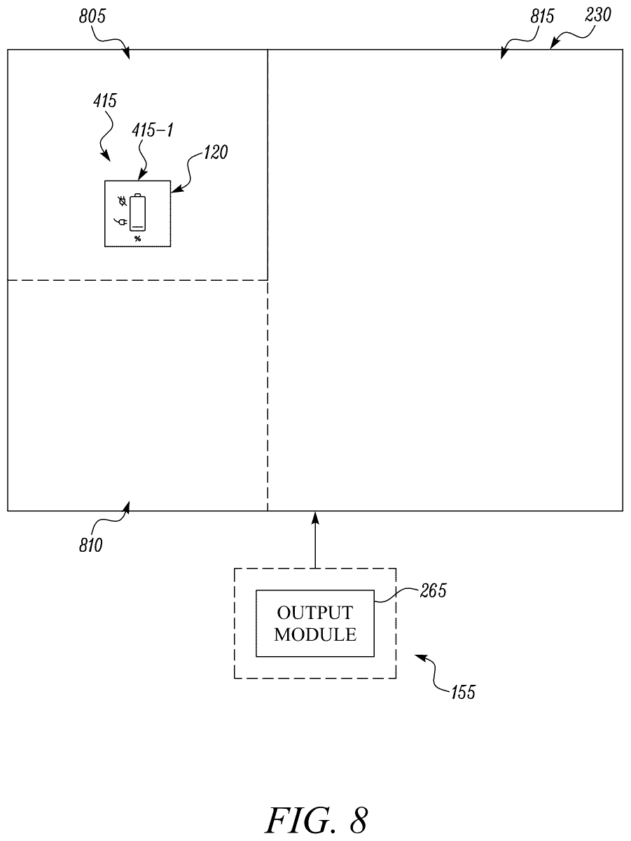

Referring to FIG. 8, in some embodiments, the output module 265 may also be configured to provide the secondary battery states, for example, 415, 415-1 of the BEMs, for example, the BEM 120, identified by the identification module 255 (see FIG. 2) as requiring the controller action on a third GUI 805 and additional

GUIs, for example, a fourth GUI 810, and a fifth GUI 815 to provide the controller actions determined corresponding to the identified BEMs and the modified SIC plan based on the controller actions respectively.

In some embodiments, the controller may be embodied in the form of a work supervisor. In such embodiments, the work supervisor operating the machine management system 155 and viewing the determined controller actions presented in the GUI may also be able to implement the determined controller actions by initiating communication with and/or providing instructions associated with the determined controller actions to the identified BEMs via the display 230 and the network 160. In some embodiments, the work supervisor may also be configured to implement the determined controller actions by initiating communication with and/or providing instructions associated with the determined controller actions to the remote maintenance devices or machines 165, 170 (see FIG. 1) via the display 230 and the network 160. For example, the work supervisor may be configured to implement the determined controller action of dispatching the maintenance vehicle to attend to an identified BEM, for example, 120 by initiating communication with a remote maintenance vehicle 170 via the display 230 and the network 160 and providing instructions to the remote maintenance vehicle 170 to navigate to a location of the identified BEM 120 in order to perform maintenance or repair of the identified BEM. In another example, the work supervisor may be configured to implement the determined controller action of directing an identified BEM, for example, 120, to the charging station S (see FIG. 1) by initiating communication with the identified BEM 120 via the display 230 and the network 160 and providing instructions to the identified BEM 120 to navigate to a location of the charging station S in order to charge the identified BEM 120.

### Industrial Applicability

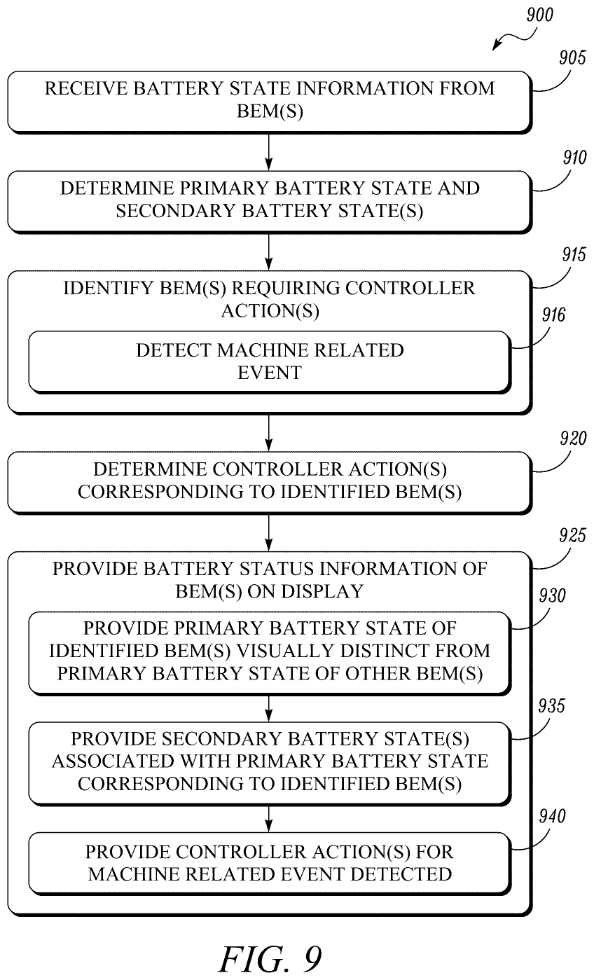

Referring to FIG. 9, an exemplary flowchart of a method 900 for managing the BEMs 105-150 of FIG. 1 operating at the worksite 101 (see FIG. 1) is disclosed. The method 900 includes a step 905 of receiving battery state information from the BEMs 105-150. The method 900 also includes a step 910 of determining a primary battery state and at least one secondary battery state associated with the primary battery state based on the received battery state information. Further, the method 900 includes a step 915 of identifying at least one BEM of the BEMs 105-150 requiring the controller action based on the primary battery state or the at least one secondary battery state. The step 915 includes a step 916 of detecting at least one machine related event. In addition, the method 900 includes a step 920 of determining the controller action for the detected machine related event corresponding to the at least one identified BEM based on the at least one secondary battery state and a short interval control (SIC) plan comprising planned tasks over a short-interval timeline. Furthermore, the method 900 includes a step 925 of providing the battery state information of the BEMs on a display, for example, the display 230. The step 925 of providing the battery state information includes a step 930 of providing the primary battery state of the at least one identified BEM visually distinct from the primary battery state of the other BEMs. Further, the step 925 of providing the battery state information includes a step 935 of providing the at least one secondary battery state associated with the primary battery state corresponding to the at least one identified BEM. In addition, step 925 of providing the battery state information includes a step 940 of providing the controller action determined.

It may be apparent that the BEM system 100, the machine management system 155 and the method 900 of the present disclosure may enable the controller, for example, the supervisor or the controller module 260, to monitor, track, and/or control the BEMs 105-150 (see FIG. 1) simultaneously in an efficient manner. For example, with aid of graphical representations such as the UI cards 510 and the digital animations provided on the display 230 (see FIG. 2) that include the primary visual indicators corresponding to the primary battery state in the neutral, cool, and warms colors, and the digital map 20 as disclosed in the present disclosure, the controller or the supervisor may be capable of identifying BEMs requiring attention accurately, reliably, and in a short period of time with minimal distractions. In addition, with aid of secondary visual indicators provided corresponding to the secondary battery states as disclosed in the present disclosure, the controller or work supervisor may be capable of obtaining additional battery state information associated with the BEMs. Moreover, with aid of the controller actions generated, implemented and/or provided on the display 230 as disclosed in the present disclosure, the controller or work supervisor may be capable of automating and/or taking sound operational decisions and ensure execution of the planned tasks in the SIC plan efficiently and on time. Therefore, BEM system 100, the machine management system 155 and the method 900 of the present disclosure may improve productivity of overall operations at the worksite 101. Furthermore, the BEM system 100, the machine management system 155 and the method 900 of the present disclosure may also provide a cognitively safe GUI with minimal distractions for monitoring and managing the multiple BEMs 105-150 simultaneously and thereby, protect an eyesight and health of the controller embodied as the work supervisor.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for managing battery electric machines (BEMs) at a worksite, comprising:
a transceiver and a processor communicably coupled thereto; the processor configured to:
receive battery state information from the BEMs operating at the worksite via the transceiver;
determine a primary battery state and at least one secondary battery state associated with the primary battery state based on the received battery state information;
identify at least one BEM of the BEMs requiring at least one controller action based on the primary battery state or the at least one secondary battery state, wherein the identifying comprises detecting at least one machine related event;
determine the at least one controller action for the at least one detected machine related event corresponding to the at least one identified BEM based on the at least one secondary battery state and a short interval control (SIC) plan comprising a plurality of planned tasks over a short-interval timeline; and
provide the battery state information of the BEMs on a display, wherein the providing comprises:
providing the primary battery state of the at least one identified BEM visually distinct from the primary battery state of the other BEMs,
providing the at least one secondary battery state associated with the primary battery state corresponding to the at least one identified BEM, and
providing the at least one controller action determined.

2. The system of claim 1, wherein the primary battery state corresponds to at least one of a battery charging state, a battery consumption state, or a battery fault state.

3. The system of claim 1, wherein the at least one secondary battery state is indicative of at least one of a battery charge, a battery temperature, an electric power train temperature, a depth of discharge (DoD), a time of receipt of the battery state information, the target battery charge associated with the BEMs, a first estimated time for the battery charge to be greater than or equal to the target battery charge, a second estimated time for the battery charge to be less than or equal to the threshold battery charge, a regenerative battery charging state, electric power connection state, a number of battery cycles, a battery capacity, battery power supply disruption, a battery fault, a battery charging fault, or a battery connection fault.

4. The system of claim 2, wherein a battery charge of the at least one identified BEM is less than or equal to a threshold battery charge in the battery consumption state and greater than or equal to a target battery charge in the battery charging state.

5. The system of claim 2, wherein the primary battery state of at least one identified BEM corresponds to the battery fault state.

6. The system of claim 1, wherein a battery or electric power train temperature of the at least one identified BEM is greater than or equal to a threshold battery temperature.

7. The system of claim 1, wherein the processor is configured to implement the at least one determined controller action and the at least one determined controller action corresponds to at least one of:
dispatching a maintenance vehicle to attend to the at least one identified BEM;
dispatching the at least one identified BEM for operation when a battery charge of the at least one identified BEM is greater than a target battery charge;
directing the at least one identified BEM to a charging station when the battery charge of the at least one identified BEM is less than a threshold battery charge; or
modifying the SIC plan, wherein the modifying comprises reassigning the at least one identified BEM from a first planned task of the plurality of planned tasks assigned to the at least one identified BEM to a second planned task of the plurality of planned tasks or reassigning the first planned task assigned to the at least one identified BEM to at least one of the other BEMs in the short-interval timeline.

8. The system of claim 2, wherein the processor is configured to provide the primary battery state or the at least one secondary battery state corresponding to the battery consumption state, the battery charging state, and the battery fault state, visual distinct from each other.

9. The system of claim 2, wherein the providing of the primary battery state comprises:
providing a primary visual indicator associated with the determined primary battery state in a first color until the battery charge of the corresponding BEM is greater than or equal to a target battery charge in the battery charging state, and causing a change in color thereafter;
providing the primary visual indicator in a second color until a battery charge of a corresponding BEM of the BEMs is less than or equal to a threshold battery charge in the battery consumption state, and causing a change in color of the primary visual indicator thereafter; and
providing the primary visual indicator in a third color in the battery fault state.

10. The system of claim 9, wherein the primary visual indicator rendered in the third color, or the change in color of the primary visual indicator is indicative of the at least one identified BEM requiring the at least one controller action on the at least one GUI.

11. The system of claim 9, wherein the providing of the at least one secondary battery state comprises:
providing a secondary visual indicator associated with the at least one secondary battery state on the display in response to receiving a controller input corresponding to the primary visual indicator.

12. The system of claim 1, wherein the providing of the battery state information on the display comprises:
providing at least one graphical user interface (GUI) comprising at least one graphical representation of the BEMs respectively on the display, wherein the at least one graphical representation comprises a primary visual indicator associated with the determined primary battery state.

13. The system of claim 12, wherein the at least one graphical representation of the BEMs corresponds to at least one of images, icons, clipart, graphics, user interface (UI) cards, or animations.

14. The visual monitoring system of claim 13, wherein the at least one GUI comprises a first GUI and a second GUI and the processor is configured to provide the at least one graphical representation of the BEMs as the UI cards in the first GUI and a digital map of the worksite on the second GUI.

15. The system of claim 14, wherein the processor is configured to provide at least one of a geographical location of the BEMs in the digital map, the at least one graphical representation of the BEMs at the geographical location in the digital map, an animated movement of the BEMs on the digital map, or the primary visual indicator corresponding to the at least one graphical representation in the digital map.

16. The system of claim 14, wherein each UI card of the UI cards rendered in the first GUI is associated with a corresponding graphical representation of a BEM of the BEMs in the second GUI.

17. The system of claim 16, wherein upon receiving a controller input corresponding to a UI card of the UI cards in the first GUI, the processor is configured to identify and visually display the corresponding graphical representation of the BEM associated with the UI card in the digital map provided in the second GUI.

18. The system of claim 12, wherein the processor is configured to modify the SIC plan based on the at least one determined controller action and provide the modified SIC plan on the at least one GUI.

19. A battery electric machine (BEM) system, comprising:
battery electric machines (BEMs); and
a system in communication the BEMs via a network, wherein the system is configured to:
receive battery state information from the BEMs operating at a worksite via the transceiver;
determine a primary battery state and at least one secondary battery state associated with the primary battery state based on the received battery state information;
identify at least one BEM of the BEMs requiring at least one controller action based on the primary battery state or the at least one secondary battery state, wherein the identifying comprises detecting at least one machine related event;
determine the at least one controller action for the at least one detected machine related event corresponding to the at least one identified BEM based on the at least one secondary battery state and a short interval control (SIC) plan comprising a plurality of planned tasks over a short-interval timeline; and
provide the battery state information of the BEMs on a display, wherein the providing comprises:
providing the primary battery state of the at least one identified BEM visually distinct from the primary battery state of the other BEMs,
providing the at least one secondary battery state associated with the primary battery state corresponding to the at least one identified BEM, and
providing the at least one controller action determined.

20. A method for managing battery electric machines (BEMs) at a worksite, comprising:
receiving battery state information from the BEMs operating at the worksite;
determining a primary battery state and at least one secondary battery state associated with the primary battery state based on the received battery state information;
identifying at least one BEM of the BEMs requiring at least one controller action based on the primary battery state or the at least one secondary battery state, wherein the identifying comprises detecting at least one machine related event;
determining the at least one controller action for the at least one detected machine related event corresponding to the at least one identified BEM based on the at least one secondary battery state and a short interval control (SIC) plan comprising a plurality of planned tasks over a short-interval timeline; and
providing the battery state information of the BEMs on a display, wherein the providing comprises:
providing the primary battery state of the at least one identified BEM visually distinct from the primary battery state of the other BEMs,
providing the at least one secondary battery state associated with the primary battery state corresponding to the at least one identified BEM, and
providing the at least one controller action determined.
